(19) United States
(12) Patent Application Publication
(10) Pub. No.: US 2010/0023853 A1
(43) Pub. Date: Jan. 28, 2010

(54) WINDOWS PRESENTATION FOUNDATION BASED UI GENERATION FOR ABSTRACT WSDLS

(75) Inventor: Chandra Kamalakantha, Plano, TX (US)

Correspondence Address: HEWLETT-PACKARD COMPANY;Intellectual Property Administration, 3404 E. Harmony Road, Mail Stop 35, FORT COLLINS, CO, 80528, US

(73) Assignee: Electronic Data Systems Corporation, Plano, TX (US)

(21) Appl. No.: 12/180,330

(22) Filed: Jul. 25, 2008

(51) Int. Cl. G06F 3/14

(52) U.S. Cl. 715/234

(57) ABSTRACT

Systems and method are disclosed for the automated generation of user interfaces and applications. These methods include selecting a mark up language document for creating an application, and obtaining user input for creating the user interface. These methods also include parsing the mark up language document to obtain at least one server parameter for the application, and using previously generated code to create a user interface for the application. This application can be stored in a computer readable medium.

### TECHNICAL FIELD

The present disclosure relates to user interfaces in general, and more specifically to the automated generation of user interfaces.

### BACKGROUND OF THE DISCLOSURE

In order to display information on a computer, a user interface is needed. However, programming a user interface is a difficult and time consuming task. User interface creation historically requires a number of phases, including a prototyping phase, a design phase, a revision phase, a testing phase, and a deployment phase. Each of these phases is time consuming and expensive. A system that could speed development of user interfaces is desirable.

In addition, these user interfaces often rely upon a particular technology limiting the ability to deploy the user interface to only those machines that have access to that particular technology. Since most user interfaces are static, they cannot adapt quickly to changing standards or technology. A dynamically adaptable system that could dynamically generate a user interface based on any technology is desirable.

Yet another problem with user interface creation is that existing user interfaces are often locked into a particular resolution. This resolution may be too small for some devices or too large for others. In either case, a system that could dynamically generate a resolution specific user interface would be desirable.

There is, therefore, a need in the art for an automatic user interface generator.

### SUMMARY OF THE DISCLOSURE

An embodiment provides systems and methods for automatically generating a user interface. This embodiment uses information stored in a web services description language document to render a user interface and deploy the user interface.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 depicts a block diagram of an automated user interface generator system in which an embodiment can be implemented; and

FIG. 3 is a flowchart of a process in accordance with an embodiment.

### DETAILED DESCRIPTION

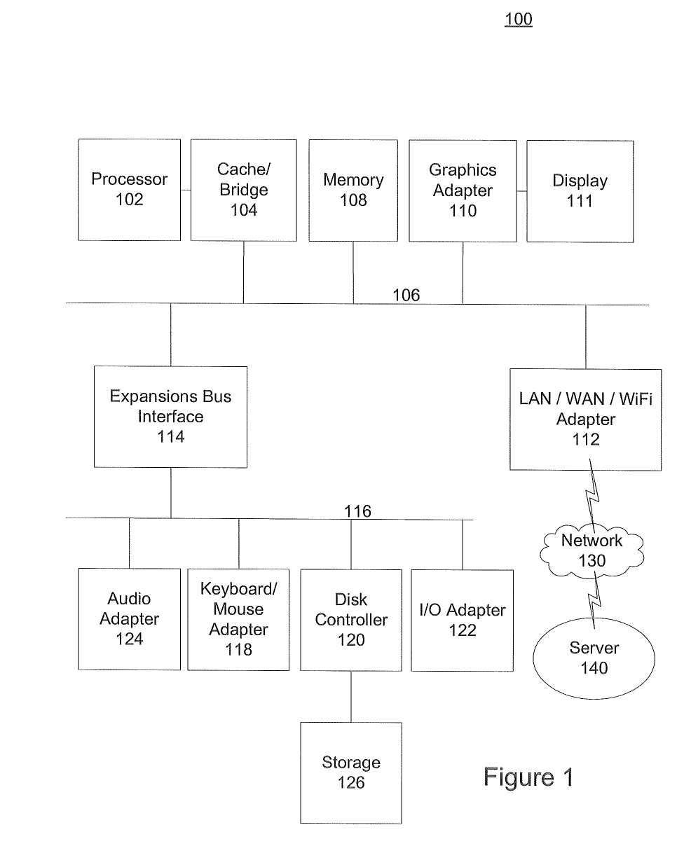

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

The following are short definitions of the usual meanings of some of the technical terms and phrases which are used in the present application. (However, those of ordinary skill will recognize whether the context requires a different meaning.) Additional definitions can be found in the standard technical dictionaries and journals.

Asynchronous Javascript and XML (“AJAX”)—AJAX is a group of various data processing techniques including the document object model, javascript, and markup languages. These techniques are used to create and deploy small segments of code to an end user machine that are executed on an end users machine and communicate with a server.

Cascading Style Sheet (“CSS”)—CSS is a stylesheet language used to describe the presentation of a document written in a markup language. CSS can define colors, fonts, layout, and other aspects of document presentation. CSS allows for the separation of document content (in a markup language) from document presentation (written in CSS). One of the features of CSS is that a priority scheme is used to determine which style rules apply if more than one rule matches against a particular element. This gives rise to the “cascade” where priorities or weights are calculated and assigned to rules. CSS can be implemented as templates to determine the attributed of an outputted web page.

Hypertext Markup Language (“HTML”) HTML is a format used to allow information to be properly formatted and displayed on a computer.

Hypertext Transfer Protocol (“HTTP”)—is a communications protocol that is used to transfer information over a network. HTTP is commonly viewed as a request/response standard between a client (end user) and a server (content provider). The application making an HTTP request may be a web browser, spider, or other end-user tool. This application is sometimes referred to as a user agent. The responding server, which stores content or creates resources, is referred to as the origin server.

Extensible Markup Language (“XML”)—XML is a general-purpose specification for creating custom markup languages. One of the advantages of XML users can define their own elements, and XML may be used with other technologies to send and display data.

Windows communication foundation (“WCF”)—WCF is a set of technologies for building and running connected systems.

Web Services Description Language (“WSDL”)—WSDL is an mark up language format for describing network services as a set of endpoints operating on messages containing either document-oriented or procedure-oriented information. The operations and messages are described abstractly, and then bound to a concrete network protocol and message format to define an endpoint. Related concrete endpoints are combined into abstract endpoints (services).

Windows presentation foundation (“WPF”)—The WPF provides a foundation for building applications together using an application user interface (“UI”), documents, and media content. A UI can be part of an application, with the UI presenting options for the application.

Traditionally, HTML has been displayed on a personal computer with a graphics resolution of at least Video Graphics Array (VGA) standard (640×480 pixels). However, with advances in technology, HTML can now be send to a plurality of devices with resolutions both far smaller than and far greater than VGA. One of the challenges then is finding systems and methods that allow for the reformatting of HTML to fit these pluralities of devices.

Designing internet websites or internet applications is a long and time consuming process. This process can include several phases, including, but not limited to, proposing a project, designing a UI, revising the UI, designing the code that is used by the UI, and deploying the UI. During the design phase, design teams typically start by prototyping UI implementations on visual slides (e.g. representations of a UI without meaning) or on a Java platform without real functionality. These prototypes are often unusable, as they are not back-end wired, do not have functional code, and do not conform to any design (GUI) or coding guidelines. These prototypes waste both time and energy as they cannot be used in the actual deployed websites or applications. Systems and methods that could reduce the amount of time required to design UIs are needed. Disclosed here are systems and methods for automatic UI generation (“AUIG”) based on an abstract WSDL. The AUIG uses style sheets and/or templates to create UIs. In addition, the generated code may be implemented in a tiered coding approach which allows data layer, business layer and service layer abstraction. This reduces the time required to create a UI, reduces the chances for error in UI generation, and allows for the UI code to be modified with ease.

FIG. 1 depicts a block diagram of a data processing system in which an embodiment can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. Storage 126 may be configured to comprise a plurality of abstract WSDLs or other information used in the present disclosure. Storage 126 may also be used to store a UI or application as described herein.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc. I/O bus 116 may be used to accept user input to determine the type of UI generated by the AUIG.

Those of ordinary skill in the art will appreciate that the hardware depicted in FIG. 1 may vary. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

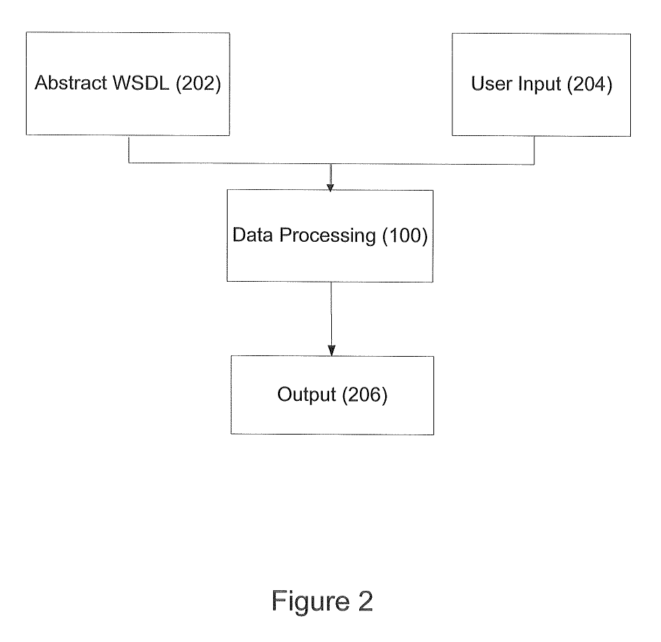

FIG. 2 is a block diagram of one embodiment of an AUIG system 200. In this system, an abstract WSDL 202 is transferred with user input 204 into the data processing system 100. The data processing system 100 uses the abstract WSDL 202 and the user input 204 in the data processing system 100 to automatically generate output 206.

Abstract WSDL 202 contains all of the operations and messages needed for a particular application. These operations and messages are described abstractly, and then bound to a concrete network protocol and message format to define an endpoint. Related concrete endpoints are combined into abstract endpoints (services). One embodiment of the abstract WSDL 202 may be used in the following format, taken from the WSDL document structure found in the WSDL 1.1 W3C working draft specification:

```
<wsdl:definitions name=“nmtoken”? targetNamespace=“uri”?>
  <import namespace=“uri” location=“uri”/>*
  <wsdl:documentation .... /> ?
  <wsdl:types> ?
    <wsdl:documentation .... />?
    <xsd:schema .... />*
    <-- extensibility element --> *
  </wsdl:types>
  <wsdl:message name=“nmtoken”> *
    <wsdl:documentation .... />?
    <part name=“nmtoken” element=“qname”? type=“qname”?/> *
  </wsdl:message>
  <wsdl:portType name=“nmtoken”>*
    <wsdl:documentation .... />?
    <wsdl:operation name=“nmtoken”>*
      <wsdl:documentation .... /> ?
      <wsdl:input name=“nmtoken”? message=“qname”>?
        <wsdl:documentation .... /> ?
      </wsdl:input>
      <wsdl:output name=“nmtoken”? message=“qname”>?
        <wsdl:documentation .... /> ?
      </wsdl:output>
      <wsdl:fault name=“nmtoken” message=“qname”> *
        <wsdl:documentation .... /> ?
      </wsdl:fault>
    </wsdl:operation>
  </wsdl:portType>
  <wsdl:binding name=“nmtoken” type=“qname”>*
    <wsdl:documentation .... />?
    <-- extensibility element --> *
    <wsdl:operation name=“nmtoken”>*
      <wsdl:documentation .... /> ?
      <-- extensibility element --> *
      <wsdl:input> ?
        <wsdl:documentation .... /> ?
        <-- extensibility element -->
      </wsdl:input>
      <wsdl:output> ?
        <wsdl:documentation .... /> ?
        <-- extensibility element --> *
      </wsdl:output>
      <wsdl:fault name=“nmtoken”> *
        <wsdl:documentation .... /> ?
        <-- extensibility element --> *
      </wsdl:fault>
    </wsdl:operation>
  </wsdl:binding>
  <wsdl:service name=“nmtoken”> *
    <wsdl:documentation .... />?
    <wsdl:port name=“nmtoken” binding=“qname”> *
      <wsdl:documentation .... /> ?
      <-- extensibility element -->
    </wsdl:port>
    <-- extensibility element -->
  </wsdl:service>
  <-- extensibility element --> *
</wsdl:definitions>
```

As shown in this example, there can be a plurality of elements defined in the abstract WSDL 202, including, but not limited to the type of data (“type”), a message being sent (“message”), an abstract description of the action (“operation”), an abstract set of operations supported by one or more endpoints (“port type”), a protocol and format for a particular port type (“binding”), a singe endpoint defined as a combination of a binding and a network address (“port”), and a collection of related endpoints (“service”). It is contemplated that any combination of these, as well as any other elements that can be defined in the abstract WSDL 202, can be used in the present disclosure.

The abstract WSDL 202 therefore defines the interrelations of the data used by a particular application. One of the problems with the abstract WSDL 202 is that it does not define a UI that can be readily deployed in a dynamic and reconfigurable manner. This problem is overcome through the use of the data processing system 100 as will be described below.

User input 204 allows a user to define certain parameters for the AUIG 200. These parameters include, but are not limited to, the definition of the type of technology to be used in the deployed UI (e.g., CSS, AJAX, etc.) as well as other user parameters (e.g., special instructions for the UI such as color schemes, data within the abstract WSDL 202 to be ignored, a specific target output resolution, or any other specified modification).

The data processing system 100 may be configured to parse the elements defined in the abstract WSDL 202 to create a list of required information needed to be deployed. This list will include data types to be both displayed by a server as well as input to be displayed to a user. Data processing system 100 also accepts the user input 204 in order to determine the type of interface to be created. It is expressly understood that the data processing system 100 can take the abstract WSDL 202 information and determine both an output (e.g., information to be displayed to the user) and an input (e.g., data to be obtained from the user).

Once the data processing system 100 has parsed the abstract WSDL 202, it will have a list of comprising the output for the user. This list may contain a plurality of data types (e.g., integers, strings, variants, etc.) as well as a plurality of relations (e.g., priority of the information and the relationships between data). For instance, in an airline reservation system, the abstract WSDL 202 may define a number of flights (integers) that correspond to descriptions (string). In addition, a flag may be present within the abstract WSDL 202 that indicates how the data should be treated. The following is an example where the output data is shown with the type, priority, and flag shown as (type, priority, flag):

Company Airlines (string, 1, x)

| Flight Number (integer, 2.1, x) | Flight (String, 2.2, y) |
|---|---|
| 1 | Chicago to Dallas |
| 2 | Dallas to Chicago |

As shown in this example, the “Company Airlines” is a string with a priority of “1”. This means that it should be displayed at wherever the highest priority location is within a UI. This highest priority location may, in some embodiments, be the top right of the UI. The flight number is shown as an integer that relates to the flight string. This relationship is demonstrated by the string 2.x notation. Since these are related, they can be displayed in a table format. The flag “x” and “y” may be used for any purpose. In the example shown above, the “x” flag indicates that the entire field should be shown if possible, and the flag “y” indicates that the field may be scaled if insufficient space exists on the output UI. Instead of a flag, it is understood that a minimum field length may be used.

The relationship of the elements may be used to determine how the elements should be displayed. For instance, if a number of elements are interrelated in the abstract WSDL 202 the data processing system 100 can determine that they should be displayed as a table. If there are a preselected number of options to be displayed, the abstract WSDL 202 may display this data as a pop-up menu. Since the abstract WSDL 202 can display any number of data types, information, messages, and rules, it is expressly understood that all relationships between data are expressly contemplated by this disclosure.

In addition to the output, the abstract WSDL 202 will also define parameters for the input. For example, if the user selects flight 1, a message may be sent to a server that reserves the flight with parameters, including, but not limited to those described above (e.g. address, port, etc.). In addition, there may be additional information required from the user (e.g. strings required from the user) that can be defined by the abstract WSDL 202 as input in the same way as the output information is described by the abstract WSDL 202. This allows the data processing system 100 to determine the type of input fields required (e.g. for a string, an edit field may be required). Therefore, the data processing system renders the complete UI including both the input and output for the user. The input can be referred to as the service input, the output can be referred to as the service output, and the data exchanged between the UI and another computer may be referred to as the service factory operation.

After the data processing system 100 completes the parsing of the abstract WSDL 202 it can use the user the user input 204 to examine the parsed data from the abstract WSDL 202 and determine the type of UI to be created. The user input 204 is used to select previously created code on which to base the new UI. Examples of the previously created code include, but are not limited to, AJAX, CSS, and HTML templates. The elements found by the parsing of the abstract WSDL 202 are displayed on the output 206 based upon the guidelines indicated by the previously created code. For instance, if the abstract WSDL 202 requires a table to be rendered, and the user input 204 indicates that AJAX has been selected, the data processing system 100 will select a listbox to be displayed. In another example, if the abstract WSDL 202 requires a user defined string to be rendered, and the user input 204 indicates that CSS has been selected, the data processing system 100 will select an editfield to be displayed. These items then will be ordered according to priority on the new UI, and will be bound to the rules defined by the previously created code. This allows the elements found with the abstract WSDL 202 to be converted into UI elements.

In the example of AJAX, an application may be generated and deployed onto a user's machine. This application will use the interface and the data types described in the abstract 202 and use a collection of AJAX stored templates. The AJAX template may include formatting information, JAVA code, or other information that may be used to accurately display information onto an end user machine.

In the example of CSS, a UI may be generated using a CSS template. These templates define how the UI will be rendered, as discussed above.

In some embodiments, the user input 204 can override the abstract WSDL definitions (e.g. pre-fill certain input fields, suppress certain output fields, etc). The data processing system 100 can use any input from the user and any web technology, including, but not limited to AJAX, CSS, and HTML to create the user interface. In addition, the data processing system 100 can restrict the dimensions of the elements in the generated UI based upon the flags shown above.

In some embodiments, the user input 204 can override the previously created code (e.g. spacing, font size, etc.) to create a customized UI. The data processing system 100 can use any input from the user to change the output 206. This allows the user to tweak the UI for special purposes (e.g., poor vision might require a larger font size, etc.)

Output 206 is generated by data processing system 100 and may comprise both a UI and code which binds the UI to another system. Output 206 is can comprise the underlining binding code need to combine the elements displayed by the user with the code required to execute commands and communicate with another system.

The use of the AUIG 200 has many unique advantages. First, it reduces the amount of work to generate the UI as all the user needs to input through user input 204 is a selection of the type of UI to be created. Second, since all of the code is generated based upon the abstract WSDL 202 using compliant AJAX, CSS templates, or plain HTML code, there is a reduced chance for bugs and the generated code will also be architecture compliant. In addition, error detection and recovery can be automated during code generation (e.g. if an invalid entry exists in the abstract WSDL 202, this error may be detected and recovered from prior to the deployment of the output 206).

The AUIG 200 also may be coupled to an end user machine to allow for the dynamic generation of applications and code based upon parameters passed by a requesting computer. For instance, if a small mobile computer with a resolution of 200×200 pixels connected to the AUIG 200, the AUIG 200 would optimize the output for the small computer. This optimization may take the form of restricting the window to 200×200 pixels, or restricting the x or y length to 200 pixels. In addition, the AUIG 200 may optimize the screen for a large screen of 1600×1200 by the allowing all information to be viewed simultaneously or by scaling the information by a factor to occupy all usable space.

The AUIG 200 not only creates the illustrative features of a UI (e.g. appearance of the UI) but also creates the backend code required to execute the UI based on the abstract WSDL 202. This means that there is a functional relationship between the UI and services, including, but not limited to secure services and other services that may not be present in a simple UI. The AUIG 200 further allows for the creation of standalone and deployable applications based upon any previously created code and abstract WSDL 202.

It is understood that the user input 204 may be displayed to a user through a graphical user interface or a text user interface. As has been described herein, the abstract WSDL 202 may comprise a plurality of services. It is understood that the user may select all or some of these services for the AUIG 200 to create a UI from. The user can have the ability to choose one, or more services made available from the abstract WSDL 202. It is therefore understood that, in some embodiments, the abstract WSDL 202 will be parsed, the results of the parsing presented to a user, and then user will create a user input 204 based upon the parsing of the abstract WSDL 202.

In some embodiments, the abstract WSDL 202 can be stored in a memory device or storage device similar to the memory devices and storage devices described in FIG. 1. In addition, the user input 204 can be implemented through one or more I/O devices as described in FIG. 1. Finally, the output 206 may be stored in one or more memory or storage devices similar to those described in FIG. 1.

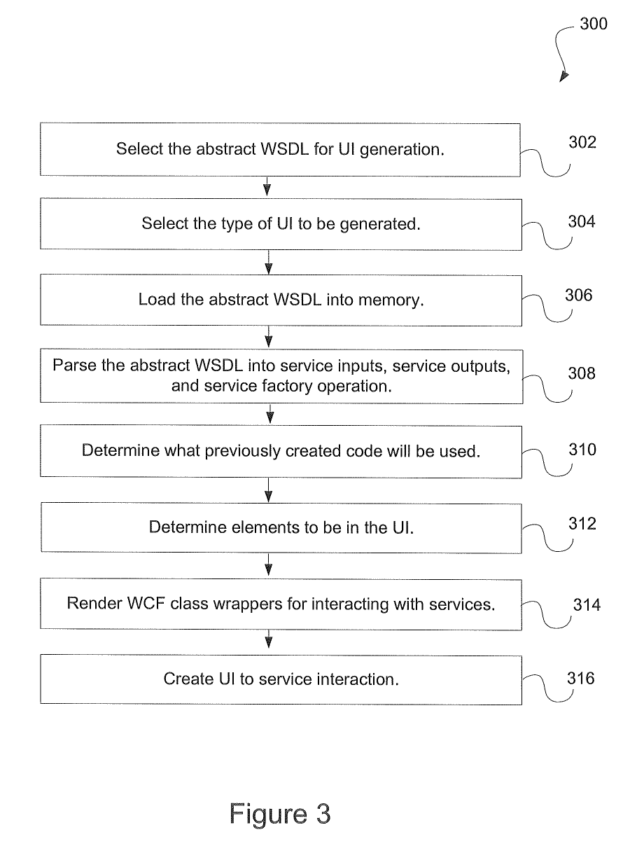

FIG. 3 is a flowchart of one method of using AUIG 200. In this method, the abstract WSDL 202 for UI generation is selected (Block 302). The type of UI to be generated is also selected (Block 304). In addition, the abstract WSDL 202 is loaded into the memory or storage of the data processing system 100 (Block 306). The abstract WSDL 202 is parsed into service inputs, service outputs, and service factory operation (Block 308). There is also a selection of what previously created code will be used (Block 310). The selection of what previously created code will be used will be based upon the type of UI to be generated. For instance, if CSS is selected, a CSS template may be used. Based upon the parsing of the abstract WSDL 202 there is a determination of what elements will be included in the UI (Block 312). In addition, the data processing system 100 can render the class wrappers for interacting with the service inputs, service outputs, and service factory operation (Block 314). The UI can be created using the interactions between the service inputs, service outputs, and service factory operation (Block 316).

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within a machine usable medium in any of a variety of forms, and that the present disclosure applies equally regardless of the particular type of instruction or signal bearing medium utilized to actually carry out the distribution. Examples of machine usable or machine readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method, comprising:
selecting a mark up language document for creating an application;
accepting user input for the application;
parsing the mark up language document to obtain at least one server parameter for the application;
obtaining previously generated code for use in the creation of the user interface for the application;
creating a user interface for the application, wherein the user interface comprises the at least one server parameter and the previously generated code;
creating the application using the server parameters for the application and the previously generated code, wherein the created application has a functional relationship to a server; and
storing the application in a computer readable format.

2. The method of claim 1, wherein the server parameters comprise a plurality of services to be integrated into the application.

3. The method of claim 1, wherein the mark up language document is an abstract web development services language (WSDL) document.

4. The method of claim 1, wherein the user parameters include technologies selected from the group: AJAX, CSS, and HTML.

5. The method of claim 1, wherein the previously generated code is a CSS style sheet.

6. The method of claim 1, wherein the abstract WSDL comprises service inputs, service outputs, and service factory operations.

7. The method of claim 1, wherein the user interface comprises a plurality of elements.

8. The method of claim 7, wherein the user parameters comprise the size and spacing of at least one element in the application.

9. A method, comprising:
reading an abstract web services description document;
selecting an interface technology to deploy the services in the web services description document;
parsing the abstract web services description document, wherein the parsing of the abstract web services description document results in the creation of a plurality of elements;
creating a user interface for a application based upon the plurality of elements and the interface technology; and
storing the user interface onto a computer readable medium.

10. The method of claim 9, wherein the interface technology is selected from a plurality of templates.

11. The method of claim 10, wherein the plurality of templates comprise information stored in marked up language format.

12. The method of claim 10, wherein the plurality of templates are selected from the group of CSS templates, AJAX templates, and HTML templates.

13. The method of claim 10, wherein the user interface is configured to communicate with a server.

14. The method of claim 10, wherein the plurality of elements include at least one editfield.

15. The method of claim 10, further comprising converting the plurality of elements into a plurality of user interface elements.

16. A system, comprising:
an input device coupled to a data processing system, wherein the input device accepts definable parameters for user interface generation;
a memory device coupled to the data processing system, wherein the memory device comprises a mark up language file with service parameters;
the data processing system, wherein the data processing system accepts the user definable parameters for user interface generation and the server parameters and generates a user interface; and
an output device, wherein the output device stores the user interface in a computer readable format.

17. The system of claim 16, wherein the system stores the user interface in random access memory.

18. The system of claim 16, wherein the input device is used to select a template for the user interface.

19. The system of claim 16, wherein the mark up language is a web services definition language file.

20. The system of claim 16, wherein the data processing system further creates an stand alone application using the user interface.
